(19) United States
(12) Patent Application Publication
(10) Pub. No.: US 2008/0258331 A1
(43) Pub. Date: Oct. 23, 2008

(54) Method for Making an Injection-Moulded Abrasive Article

(75) Inventors: Jean Le Normand, Versailles (FR); Jonathan M. Lise, Woodbury, MN (US); Gerhard Lohmeier, Koeln (DE); Pierre M. Congard, Saint Berthevin (FR)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 11/569,097

(22) PCT Filed: Apr. 8, 2005
(86) PCT No.: PCT/US05/11865

§ 371 Date: Apr. 8, 2008

(30) Foreign Application Priority Data
May 20, 2004 (GB) 0411268.6

(51) Int. Cl. C08J 5/14

(52) U.S. Cl. 264/128

(57) ABSTRACT

A method for making an abrasive article is disclosed. An exemplary embodiment comprises positioning particles of abrasive agglomerate (10) in at least a portion (8) of an abrasive article mould (2), injecting molten thermoplastic binder resin into the abrasive article mould (2) and allowing the thermoplastic binder resin to cool such that the particles or abrasive agglomerate (10) are secured within the thermoplastic binder resin.

This invention relates to a method for making a moulded abrasive article and in particular to a method of making a moulded abrasive article which comprises injection moulding a thermoplastic binder resin into a mould containing abrasive material.

Abrasive products formed of a solid organic polymeric matrix having abrasive granules dispersed throughout and bonded therein are well known and widely used. Typically the polymeric matrix is composed of either a hard thermoset resin, such as a base catalysed phenolic formaldehyde, or a resilient elastomeric resin, such as a polyurethane. Typically, precursors of the resin are admixed with abrasive granules and introduced into a mould. The mould is heated to a sufficiently high temperature for a period of time to cause reaction of the precursors to form a cured resin system. It is known to make moulded abrasive articles by injection moulding a thermo formable material having an abrasive grit intermixed homogenously therein. Such processes are disclosed, for example, in U.S. Pat. Nos. 5,209,760, 5,232,470, 5,607,488 and 5,632,790 and WO96/33638 and EP 551714.

U.S. Pat. No. 6,179,887 discloses a method for making an abrasive article comprising the steps of:

supplying an effective amount of abrasive particles to at least a portion of an abrasive article mould, wherein the abrasive article comprises a plurality of bristle segment portions;
supplying a binder precursor matrix to the abrasive article mould wherein the binder precursor matrix comprises at least two interactive components selected from the group consisting of a polyurethane/urea binder and an epoxy binder; and
allowing the binder precursor to cure within the abrasive article mould such that the abrasive particles are secured within a binder formed from the binder precursor matrix. Generally the mould is heated e.g. to a temperature of 60 to 80° C. for about 1 hour to partially cure the binder and thereafter the abrasive article is removed from the mould and additionally cured e.g. at 100° C. for 18 to 24 hours. The binder precursor is supplied to the mould by injection e.g. under a pressure of about 100 psi.

One of the disadvantages of employing a curable resin binder is that the production of the moulded articles tends to be slow in view of the time required for complete curing of the resin binder system.

The production of moulded abrasive articles by injection moulding a mixture of thermoplastic material and abrasive material provides a faster process but suffers from several disadvantages. Firstly, the amount of abrasive material which can be incorporated into the thermoplastic resin and successfully injected into a mould is limited, typically to less than 10% by volume. Secondly, the entire moulded article is filled with abrasive material and there may be regions of the article where abrasive is not required. Thirdly, the wear on the injection moulding plastification unit of the machine, comprising the screw barrel and check valve, due to the presence of abrasive particles is severely high.

Attempts to produce moulded articles by introducing abrasive particles into a mould followed by injection moulding of a thermoplastic resin have not proved to be particularly successful. Firstly, the abrasive particles must have a sufficient size and distribution within the mould which will allow the molten thermoplastic resin to completely fill the interstices between the particles in order to ensure the particles are retained within a matrix of the thermoplastic resin. Secondly, the bond between the thermoplastic resin and the abrasive particle is not very strong since mineral particles tend to have smooth surfaces. Thirdly, there is a tendency for the abrasive particles to become displaced when the thermoplastic resin is injected to the mould, particularly when small particles of abrasive are used.

The invention has been made with the above points in mind.

According to the invention there is provided a method for making an abrasive article comprising positioning particles of abrasive agglomerate in at least a portion of an abrasive article mould, injecting molten thermoplastic binder resin into the abrasive article mould and allowing the thermoplastic binder resin to cool such that the particles of abrasive agglomerate are secured within the thermoplastic binder resin.

It has been found that the use of particles of abrasive agglomerates readily allows the production of moulded abrasive articles by injection moulding thermoplastic binder resin into an abrasive article mould containing the particles of abrasive agglomerate. The agglomerates typically have a particle size of at least 0.5 millimetres and comprise a plurality of abrasive particles bonded together with a binder. The particles of abrasive agglomerate are sufficiently large to facilitate passage of molten thermoplastic polymer there between and tend to have a rough surface comprising projecting portions of abrasive which provide good anchorage to the thermoplastic binder.

Since the abrasive does not pass through the injection moulding plastification unit in the process of the invention, the wear on the injection moulding machine is minimal. Since the particles of abrasive agglomerates are introduced into the mould separate from the thermoplastic binder, high abrasive loading levels in the moulded article may readily be achieved, far higher than can be achieved by a process which comprises an injection moulding composition of abrasive particles and thermoplastic resin. Furthermore, by suitable mould design and placement of the particles of abrasive agglomerate, abrasive loading can be confined to desired locations. Thus, parts of the moulded abrasive article e.g. for an attachment system, backing plate etc. may be free from abrasive.

The term “abrasive agglomerate” used herein refers to a particle comprising a plurality of abrasive particles held together by a binder. Alternate terms for an abrasive “particle” are “particulate”, “mineral”, “grit”, “grain” and “granule”. In the balance of this document, the term “grain” is used to indicate the basic abrasive particle and “agglomerate” to indicate a larger particle comprising a number of abrasive grains bound in a binder matrix.

The abrasive agglomerate may optionally comprise other additives e.g. filler, coupling agent, grinding agent, surfactant, wetting agent, pigments, dyes, plasticizer and suspending agent. The binder may be organic and/or inorganic. The abrasive agglomerates may be randomly shaped or have a predetermined shape associated with them. The shape may be a block, cylinder, pyramid, coin, square or the like. The average particle size of the abrasive agglomerate is preferably at least 0.5 millimetres by sieve analysis. Particularly useful particles of abrasive agglomerate have an average size within the range 0.2 to 3 millimetres, preferably 0.5 to 2 millimetres by sieve analysis. The grit size of the individual abrasive grains forming the agglomerate may be selected depending upon the ultimate use of the abrasive material. Grit sizes in the range P12 to P3000 may be used.

Suitable abrasive agglomerates and processes for their preparation are disclosed, for example, in U.S. Pat. Nos. 4,311,489, 4,652,275, 4,799,939, 5,549,962, 5,975,988, 6,521,004, 6,620,214 and 200/0095871; and WO02/33019, WO02/33030, WO02/32832 and WO02/094506.

Exemplary abrasive grains that are useful in the abrasive agglomerates include fused aluminium oxide abrasive grains, ceramic aluminium oxide abrasive grains, white fused aluminium oxide abrasive grains, heat treated aluminium oxide abrasive grains, brown fused aluminium oxide abrasive grains, silica abrasive grains, silicon carbide abrasive grains, green silicon carbide abrasive grains, boron carbide abrasive grains, titanium carbide abrasive grains, alumina-zirconia abrasive grains, diamond abrasive grains, ceria abrasive grains, or combinations thereof. The ceramic aluminium oxide is preferably made according to a sol gel process, such as described in U.S. Pat. Nos. 4,314,827, 4,744,802, 4,623,364, 4,770,671, 4,881,951, 5,011,508 and 5,213,591, or by a process of sintering anhydrous alumina powders such as described in U.S. Pat. Nos. 5,593,467, 5,645,618 and 5,651,801. The ceramic abrasive grain comprises alpha alumina and, optionally, a metal oxide modifier, such as magnesia, zirconia, zinc oxide, nickel oxide, hafnia, yttria, silica, iron oxide, titania, lanthanum oxide, ceria, neodymium oxide, and combinations thereof. The ceramic aluminium oxide may also optionally comprise a nucleating agent, such as alpha alumina, iron oxide, iron oxide precursor, titania, chromia, or combinations thereof. The ceramic aluminium oxide may also have a shape, such as that described in U.S. Pat. Nos. 5,201,916 and 5,090,968.

Abrasive grains may also have a surface coating. A surface coating can improve the adhesion between the abrasive grains and the binder in the agglomerate and/or can alter the abrading characteristics of the agglomerate. Such surface coatings are described in U.S. Pat. Nos. 5,011,508, 1,910,444, 3,041,156, 5,009,675, 5,213,591 and 5,042,991.

An abrasive grain may also contain a coupling agent on its surface, such as a silane coupling agent. Coupling agents tend to enhance the adhesion between a solid surface, such as, for example, abrasive grains and curable binder precursor. Examples of coupling agents suitable for this invention include organo-silanes, zircoaluminates and titanates.

As used in the present invention, abrasive grains typically have an average particle size ranging from about 125 to 1500 micrometers. Useful abrasive grains typically have a Mohs hardness of at least about 7, preferably of at least about 8 and more preferably above 9. The expression “Mohs hardness” means a value corresponding to a number on the “Mohs scale.” “Mohs scale” is defined as a scale of hardness for minerals (see Lafferty, Peter, “The Dictionary of Science”, p. 386 (1993) or “Handbook of Chemistry and Physics”, p. F-22 (1975)).

Particularly preferred particles of abrasive agglomerate are prepared in accordance with the process described in WO02/33019, with the exception that thermally cured resole phenyl-formaldehyde resin is used in place of radiation cured acrylic resin. Also, the particles of agglomerate are in the form of “ceramic aggregate precursor particles” combining abrasive particles and cured organic binder and not subjected to the final high temperature firing process which transforms the particles into ceramic aggregate particles as disclosed in WO02/33019. Preferred abrasive grains are aluminium oxide abrasive grain, particularly heat treated fused aluminium oxide abrasive grains, commercially available from Treibacher, Vallach Austria under the trade mark ALODUR FRPL. A preferred resole phenol-formaldehyde resin comprises a 75% by weight solid aqueous dispersion of a resole phenol-formaldehyde resin having a phenol to formaldehyde ratio of 1.5 to 2.0:1 and catalysed with 2.5% by weight of sodium hydroxide based on the weight of resin.

A wide range of materials may be used as the thermoplastic binder resin including thermoplastic polymers (TP) and thermoplastic elastomers (TPE).

Examples of suitable thermoplastic polymers for use in the invention include polycarbonate, polyetherimide, polyester, polyethylene, polysulfone, polystyrene, polybutylene, acrylonitrile-butadiene-styrene block copolymer, polypropylene, acetal polymers, polyurethanes, polyamides, and combinations thereof. In general, preferred thermoplastic polymers of the invention are those having a high melting temperature and good heat resistance properties. Examples of commercially available thermoplastic polymers suitable for use with the present invention include Grilon™ CR9 copolymer of Nylon 6,12 available from EMS-American Grilon, Inc., Sumter, S.C.; Profax™ and KS075 polypropylene based thermoplastic available from Himont USA, Inc., Wilmington, Del.; and Duraflex™ polybutylene based thermoplastic available from Shell Chemical Co., Houston, Tex.

One particular thermoplastic polymer suitable for use with the present invention is a polyamide resin material, which is characterized by having an amide group, i.e., —C(O)NH—. Various types of polyamide resin materials, i.e., nylons, can be used, such as nylon 6/6 or nylon 6. Nylon 6/6 is a condensation product of adipic acid and hexamethylenediamine. Nylon 6/6 has a melting point of about 264° C. and a tensile strength of about 770 kg/cm2 Nylon 6 is a polymer of s-caprolactam. Nylon 6 has a melting point of about 220° C. and a tensile strength of about 700 kg/cm². Examples of commercially available nylon resins useable according to the present invention include “Vydyne” from Monsanto, St. Louis, Mo.; “Zytel” and “Minion” both from Du Pont, Wilmington, Del.; “Trogamid T” from Huls America, Inc., Piscataway, N.J.; “Capron” from Allied Chemical Corp., Morristown, N.J.; “Nydur” from Mobay, Inc., Pittsburgh, Pa.; and “Ultramid” from BASF Corp., Parsippany, N.J.

In some instances, such as high speed, high stress applications, it is preferred that the mouldable polymer is a thermoplastic elastomer or includes a thermoplastic elastomer. Thermoplastic elastomers (or TPEs) are defined and reviewed in “Thermoplastic Elastomers. A Comprehensive Review”, edited by N. R. Legge, G. Holden and H. E. Schroeder, Hanser Publishers, New York, 1987 (referred to herein as “Legge et al.”). Thermoplastic elastomers (as used herein) are generally the reaction product of a low equivalent weight polyfunctional monomer and a high equivalent weight polyfunctional monomer, wherein the low equivalent weight polyfunctional monomer has a functionality of at most about 2 and equivalent weight of at most about 300 and is capable on polymerization of forming a hard segment (and, in conjunction with other hard segments, crystalline hard regions or domains) and the high equivalent weight polyfunctional monomer has a functionality of at least about 2 and an equivalent weight of at least about 350 and is capable on polymerization of producing soft, flexible chains connecting the hard regions or domains.

“Thermoplastic elastomers” differ from “thermoplastics” and “elastomers” (a generic term for substances emulating natural rubber in that they stretch under tension, have a high tensile strength, retract rapidly, and substantially recover their original dimensions) in that thermoplastic elastomers, (unlike elastomers), upon heating above the melting temperature of the hard regions, form a homogeneous melt which can be processed by thermoplastic techniques such as injection moulding. Subsequent cooling leads again to segregation of hard and soft regions resulting in a material having elastomeric properties, which, however, does not occur with thermoplastics. Thermoplastic elastomers combine the processability (when molten) of thermoplastic materials with the functional performance and properties of conventional thermosetting rubbers (when in their non-molten state), and which are described in the art as ionomeric, segmented, or segmented ionomeric thermoplastic elastomers. The segmented versions comprise “hard segments” which associate to form crystalline hard domains connected together by “soft”, long, flexible polymeric chains. The hard domain has a melting or disassociation temperature above the melting temperature of the soft polymeric chains.

Commercially available thermoplastic elastomers (TPEs) include segmented thermoplastic elastomers, blends of thermoplastic elastomers and thermoplastic polymers, and ionomeric thermoplastic elastomers.

“Segmented thermoplastic elastomer”, as used herein, refers to the sub-class of thermoplastic elastomers which are based on polymers which are the reaction product of a high equivalent weight polyfunctional monomer and a low equivalent weight polyfunctional monomer. Segmented thermoplastic elastomers are preferably the condensation reaction product of a high equivalent weight polyfunctional monomer having an average functionality of at least 2 and an equivalent weight of at least about 350, and a low equivalent weight polyfunctional monomer having an average functionality of at least about 2 and an equivalent weight of less than about 300. The high equivalent weight polyfunctional monomer is capable on polymerization of forming a soft segment, and the low equivalent weight polyfunctional monomer is capable on polymerization of forming a hard segment. Segmented thermoplastic elastomers useful in the present invention include polyester TPEs, polyurethane TPEs, and polyamide TPEs, and silicone elastomer/polyimide block copolymeric TPEs, with the low and high equivalent weight polyfunctional monomers selected appropriately to produce the respective TPE.

The segmented TPEs preferably include “chain extenders”, low molecular weight (typically having an equivalent weight less than 300) compounds having from about 2 to 8 active hydrogen functionality, and which are known in the TPE art. Particularly preferred Examples include ethylene diamine and 1,4-butanediol.

“Ionomeric thermoplastic elastomers” refers to a sub-class of thermoplastic elastomers based on ionic polymers (ionomers). Ionomeric thermoplastic elastomers are composed of two or more flexible polymeric chains bound together at a plurality of positions by ionic associations or clusters. The ionomers are typically prepared by copolymerization of a functionalized monomer with an olefinic unsaturated monomer, or direct functionalisation of a preformed polymer. Carboxyl-functionalized ionomers are obtained by direct copolymerization of acrylic or methacrylic acid with ethylene, styrene and similar comonomers by free-radical copolymerization. The resulting copolymer is generally available as the free acid, which can be neutralized to the degree desired with metal hydroxides, metal acetates, and similar salts. A review of ionomer history and patents concerning same is provided in Legge et al., pp. 231-243.

Blends of TPE and TP materials are also useful as the thermoplastic binder resin in the method of the invention, allowing even greater flexibility in tailoring mechanical properties of the abrasive articles of the invention.

Commercially available and preferred segmented polyester TPEs include those known under the trade designations “Hytrel™ 4056”, “Hytrel™ 5526”, “Hytrel™ 5556”, “Hytrel™ 6356”, “Hytrel™ 7246”, and “Hytrel™ 8238” available from E.I. Du Pont de Nemours and Company, Inc., Wilmington, Del., with the most preferred including Hytrel™ 5526, Hytrel™ 5556, and Hytrel™ 6356. A similar family of thermoplastic polyester TPE is available under the trade name RITEFLEX (Hoechst Celanese Corporation). Still further useful polyester TPEs are those known under the trade designations ECDEL from Eastman Chemical Products, Inc., Kingsport, Tenn.; LOMAD, from General Electric Company, Pittsfield, Mass.; ARNITEL from DSM Engineered Plastics; and BEXLOY from Du Pont. Further useful polyester TPEs include those available as LUBRICOMP from LNP Engineering Plastics, Exton, Pa., and is commercially available incorporating lubricant, glass fibre reinforcement, and carbon fibre reinforcement.

Commercially available and preferred segmented polyamide TPEs include those known under the trade designation PEBAX and RILSAN, both available from Atochem Inc., Glen Rock, N.J.

Commercially available and preferred segmented polyurethane TPEs include those known under the trade designation ESTANE, available from B.F. Goodrich, Cleveland, Ohio. Other preferred polyurethane TPEs include those known under the trade designations PELLETHANE, and ISOPLAST from The Dow Corning Company, Midland, Mich., and those known under the trade designation MORTHANE, from Morton Chemical Division, Morton Thiokol, Inc.; and those known under the trade designation ELASTOLLAN, from BASF Corporation, Wyandotte, Mich.

Thermoplastic elastomers are further described in U.S. Pat. No. 5,443,906.

It is preferred that the thermoplastic binder resin includes a lubricant. The presence of a lubricant in the binder reduces the friction of the abrasive material contacting the workpiece surface. This reduces the heat generated when refining the workpiece. Excessive heat may cause the abrasive material to leave residue on the workpiece or to otherwise harm the workpiece. Suitable lubricants useful with thermoplastics and thermoplastic elastomers include, for example, lithium stearate, zinc stearate, calcium stearate, aluminium stearate, ethylene bis stearamide, graphite, molybdenum disulfide, polytetrafluoroethylene (PTFE), and silicone compounds.

An example of a preferred silicone material useful as a lubricant is a high molecular weight polysiloxane of formula (A):

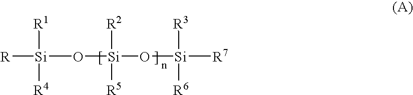

wherein R, R¹, R², R³, R⁴, R⁵, R⁶ and R⁷ may be the same or different and can be an alkyl, vinyl, chloroalkyl, aminoalkyl, epoxy, fluororalkyl, chloro, fluoro, or hydroxy, and n is 500 or greater, preferably 1,000 or greater, more preferably 1,000 to 20,000, and most preferably 1,000 to 15,000.

Another preferred polysiloxane is a polydimethylsiloxane of formula (B):

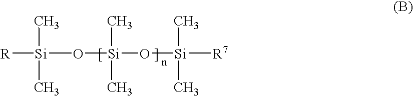

wherein R and R⁷ may be the same or different and can be an alkyl, vinyl, chloroalkyl, aminoalkyl, epoxy, fluororalkyl, chloro, fluoro, or hydroxy, and n is 500 or greater, preferably 1,000 or greater, more preferably 1,000 to 20,000, and most preferably 1,000 to 15,000.

Polysiloxanes are available in many different forms, e.g., as the compound itself or as a concentrate. Example of polymers into which the polysiloxane can be compounded include polypropylene, polyethylene, polystyrene, polyamides, polyacetal, acrylonitrile-butadiene-styrene (ABS), and polyester elastomer, all of which are commercially available. Silicone modified Hytrel™ is available commercially as BY27 010 (or MB50-010), and silicone modified Nylon 6,6 is available commercially as BY27-005 (or MB50-005), both from Dow Corning Company, Midland, Mich.

Typically, commercially available concentrates may contain a polysiloxane at a weight percent ranging from 40 to 50; however, any weight percent is acceptable for purposes of the invention as long as the desired weight percent in the final product can be achieved. Lubricants preferably can be present in the thermoplastic binder in amounts of up to about 20 percent by weight (exclusive of abrasive agglomerate content), although more or less may be used as desired.

The thermoplastic binder resin may additionally comprise a filler. A wide range of particulate and fibre fillers may be used. Generally fillers are employed in amounts of less than 20% by weight of the thermoplastic binder. A preferred filler comprises cork particles which have been found to improve moulding performance and reduce the tendency of flash formulation. In addition the presence of cork reduces the tendency of the abrasive product to leave smears on the work product during use.

In a method in accordance with the invention, the step of injecting binder resin into the abrasive article mould conveniently involves using an injection moulding machine which is capable of holding the mould in a vertical orientation. Many known injection moulding systems have a horizontal orientation and the molten material is conveyed horizontally into the side of a mould. However, since particles of abrasive agglomerate are positioned in the mould prior to injection of the molten thermoplastic binder it is convenient to design a mould cavity such that the particles of abrasive agglomerate are retained in position under gravity and to inject the molten thermoplastic material vertically downwardly into the mould.

The mould cavity may take a variety of forms depending upon the end product. The mould cavity may be substantially completely filled with particles of abrasive agglomerate if the abrasive product is in the form of a grinding wheel or the like or the mould cavity may be designed to receive particles of abrasive agglomerate in confined areas e.g. an outer surface of a disc of ring. It is important to design the mould cavity so that the particles of abrasive agglomerate are not moved to another part of the cavity when subjected to the flow of molten thermoplastic binder during the injection moulding. This can be achieved by a variety of techniques. It is desirable to design the mould cavity so that the particles of abrasive agglomerate are located at the maximum distance from the injection point of molten thermoplastic binder into the mould. In this way, even if the mould cavity is not filled with particles, the particles have nowhere to go when the flow of molten thermoplastic reaches them and therefore they are retained in the desired position. Another technique is to design the mould cavity with one or more recesses which may be filled with particles of abrasive agglomerate so that the particles are confined to the recess when subjected to the flow of molten thermoplastic binder.

According to a further technique, the particles of abrasive agglomerate may be retained within a region of the mould cavity by use of a screen, web, scrim, membrane or mesh which allows passage of molten thermoplastic binder there through but does not allow the particles of abrasive agglomerate to pass there through. Suitable materials for forming the screen include woven, non-woven, knitted and perforated materials made of plastic, metal, glass fibre, ceramic or vitreous material. For example, in the case of moulding a circular disc, one or more layers of particles of abrasive agglomerates may be applied to the base of the mould cavity and covered by a membrane or mesh to prevent movement of the particles. During injection moulding the molten thermoplastic binder flows through the mesh forming a matrix which encapsulates both the particles of abrasive agglomerate and the mesh.

The amount of abrasive agglomerate and thermoplastic binder resin used may vary widely depending upon the particular construction of the abrasive article. In some cases the abrasive agglomerate will be confined to the surface of the abrasive article and in other cases the abrasive agglomerate may be distributed throughout some or all of the abrasive articles. In general the abrasive articles comprise at least 1 part by weight thermoplastic binder resin per part by weight of abrasive agglomerate, usually from 1 to 20 parts by weight thermoplastic binder resin per part by weight of abrasive agglomerate.

Injection moulding techniques are known in the art. As mentioned, the injection moulding apparatus is conveniently designed to have a vertical orientation although it may have a horizontal orientation providing the mould cavity is oriented as described above. The injection moulding apparatus generally comprises a hopper which feeds the thermoplastic binder material, generally in the form of a powder or pellets, into a first side of a screw injector which generally comprises a screw within a barrel. The opposite side of the screw injector comprises a nozzle for passing the softened material in to the mould. The barrel of the injector is heated to melt the material and the rotating screw propels the material in the direction of the nozzle. The screw is then moved linearly towards the nozzle to impart the “shot” of molten material into the mould at the desired pressure. A gap is generally maintained between the forward end of the screw and the nozzle to provide a cushion area of softened material which is not injected into the mould.

The barrel temperature of the injection moulding apparatus is generally in the range from about 200 to 250° C. The mould is preferably heated to a temperature in the range 50 to 150° C., more preferably from about 100 to 140° C. The cycle time (the time from introducing the screw extruder to opening the mould to remove the article) is generally in the range of from 0.5 to 180 seconds, normally from about 5 to 60 seconds). The injection pressure is generally in the range 100 to 1000 psi (690 to 6900 kPa) usually from 300 to 700 psi (2070 to 4830 kPa).

The invention will now be described with reference to the accompanying drawings in which:

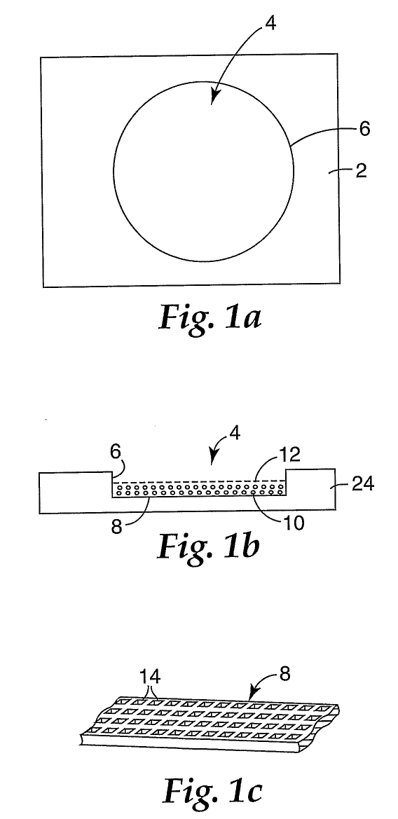

FIGS. 1a and 1b represent a plan view and section through a mould cavity for use in the invention and FIG. 1c represents an isometric view of a portion of a base which can be used in the mould,

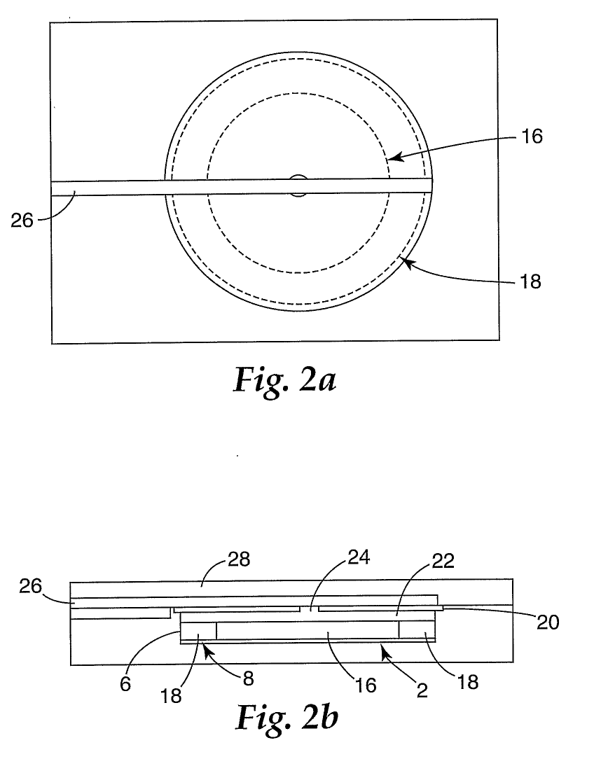

FIGS. 2a and 2b represent a plan view and section through an alternative mould for use in the invention,

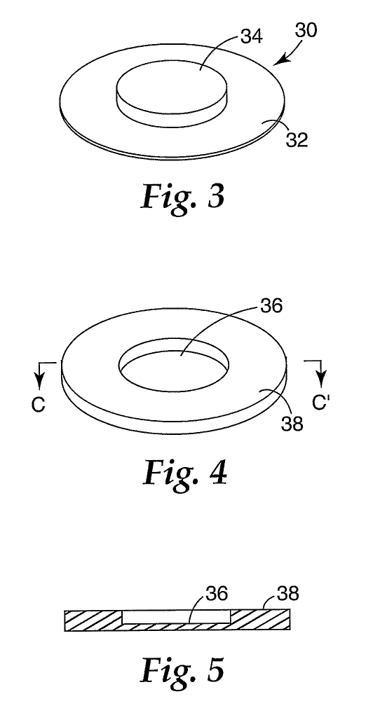

FIG. 3 represents a perspective view of a mould insert used in Example 2,

FIG. 4 represents a perspective view of a moulded article produced using the insert of FIG. 3,

FIG. 5 represents a cross-section along the line C-C′ in FIG. 4,

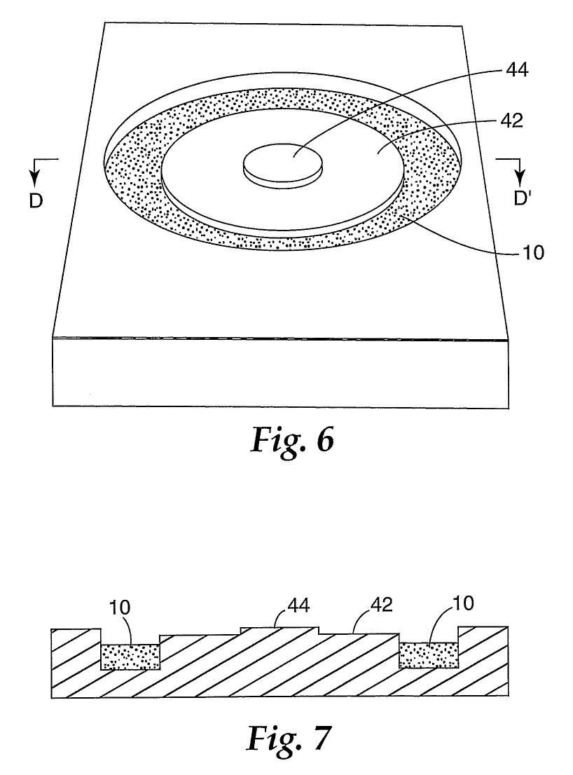

FIG. 6 represents a perspective view of the mould used in Example 3,

FIG. 7 represents a cross-section along the line D-D′ in FIG. 6,

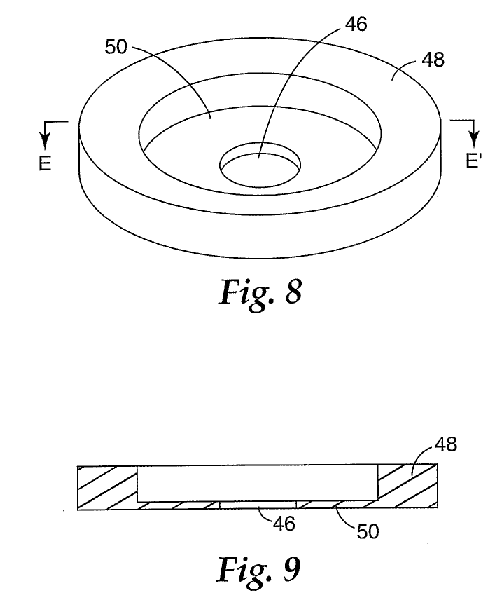

FIG. 8 represents a perspective view of a moulded article produced using the mould of FIGS. 6 and 7 and

FIG. 9 represents a cross-section along the line E-E′ in FIG. 8.

Referring to FIGS. 1a and 1b, the mould block 2 comprises a cylindrical mould cavity 4 comprising a cylindrical side wall 6 and base 8. The mould is designed to form an abrasive disc. The upper portion (top cover) of the mould is not shown. The mould used in Examples 1 and 2 had a planar top cover with a single, centrally positioned, injection port. However, the top cover may be configured to form a suitable attachment means, e.g. a central threaded boss.

One or more layers of abrasive agglomerates 10 are spread over the base 8 of the mould. In some embodiments the mould cavity may be completely filled with the particles of abrasive agglomerate. As shown in FIG. 1b, the mould cavity is not completely filled with particles of abrasive agglomerate. If necessary a screen, web, scrim or mesh 12 may be positioned over the particles of abrasive agglomerate 10 in order to ensure the particles are not displaced during flow of the molten thermoplastic during injection moulding. The mould is closed and connected to an injection moulding apparatus and molten thermoplastic binder introduced. Upon solidification of the thermoplastic binder the mould is opened and the abrasive particle removed.

A mould as shown in FIGS. 1(a) and (b) was used in Example 1. The dimensions of the moulded abrasive article are equivalent to the internal dimensions of the mould are:

| | |
|---|---|
| Outside diameter | 50 mm |
| Thickness | 5 mm |

Instead of having a flat surface as shown in FIG. 1b, the base of the mould 8 may be contoured to provide a textured surface to the moulded abrasive article. As shown in FIG. 1c, the base 8 may comprise a plurality of shaped recesses 14. Abrasive agglomerate is placed in the recesses 14 and since the particles will be confined to the recesses they will not be displaced by the flow of molten thermoplastic binder during injection moulding. The recesses 14 may be any desired shape depending upon the texture of the surface required on the abrasive article.

FIGS. 2a and 2b represent a plan view and section through a further mould suitable for use in the invention. The mould 2 comprises a cylindrical moulding cavity similar to the mould of FIG. 1. The base 8 of the mould is removable and may be replaced with mould bases having textured surfaces if required. A central removable insert 16 is positioned on the mould base to define a ring 18 formed between the inset 18 and the cylindrical wall 6. The ring is filled with particles of abrasive agglomerates prior to injection moulding.

A separation plate 20 is positioned over the cylindrical cavity, spaced above the central insert 16 such that a backing plate 22 is integrally formed with the ring of abrasive material during injection moulding. The separation plate has a central recess 24 which is in communication with conduit 26 which is connected to the injection moulding machine. Conduit 26 is formed in the cover plate 28.

In use, particles of abrasive agglomerate are introduced into the ring 18 to completely fill the ring. The separation plate 20 is placed over the moulding cavity and the lid 28 secured. Molten thermoplastic binder is introduced from an injection moulding machine through conduit 26 and enters the mould cavity via the central recess 24 in the cover plate 20. The molten thermoplastic binder flows over the insert 16 and penetrates the spaces between the particles of abrasive agglomerate in the ring 18 until it reaches the base 8 of the mould. The molten material completely fills the entire moulding cavity. Upon solidification, the lid 28 and cover plate are removed and the abrasive article removed from the mould. The article comprises a backing plate 22 formed of the thermoplastic binder supporting an abrasive ring 18 comprising particles of abrasive agglomerate within a matrix of the thermoplastic binder. If desired, a reinforcing element may be incorporated into the mould prior to injection moulding to strengthen the backing plate 22.

The mould insert shown in FIG. 3 was used in the mould shown in FIGS. 1(a) and (b) to make the products of Example 2.

The steel insert (30) was placed in the mould. The insert had an outside diameter of 50 mm with an outside annular ring (32) thickness of 0.5 mm, a centre hub (34) diameter of 24 mm with an additional thickness of 3 mm. The moulded abrasive article is shown in FIG. 4 and FIG. 5. The dimensions of the moulded abrasive article are equivalent to the internal dimensions of the mould with the insert in place and are:

| | |
|---|---|
| Outside diameter | 50 mm |
| Central thinner portion (36) diameter | 24 mm |
| Central thinner portion (36) thickness | 1.5 mm |
| Outside annular ring (38) thickness | 4.5 mm |

FIGS. 6 and 7 show the mould used in Example 3. The mould comprised an annular recess (40) having a stepped central portion (42) with an upraised boss (44) position at the centre to form a central aperture (46) in the moulded article (FIGS. 8 and 9). Agglomerate (10) is placed in the annular recess (40). The mould comprised a planar top cover (not shown) having four injection ports around the annular recess (40).

The dimensions of the moulded abrasive article are equivalent to the internal dimensions of the mould and are:

| | |
|---|---|
| Outside diameter | 103 mm |
| Diameter of inside hole (46) | 22 mm |
| Thickness of outside annular ring section (48) | 12 mm |
| Thickness of interior annular ring section (50) | 2 mm |
| Diameter of interior annular ring section (50) | 69 mm |

The invention will be illustrated by the following Examples below, in which the following materials, test methods and equipment were used:

### Materials:

“MB 50-010” a silicone modified polyester elastomer-based polymer melt additive, commercially available from Dow Corning Company, Midland, Mich., USA. [under the trade designation “MB 50-010”.]

“Hytrel™ 6356” a polyester-based TPE (thermoplastic elastomer) commercially available from E.I. Du Pont de Nemours and Company, Inc., Wilmington, Del., USA. [under the trade designation: “Hytrel™ 6356”.]

“Hytrel™ 5526” a polyester-based TPE (thermoplastic elastomer) commercially available from E.I. Du Pont de Nemours and Company, Inc., Wilmington, Del., USA. [under the trade designation: “Hytrel™ 5526”.]

“Hytrel™ 4056” a polyester-based TPE (thermoplastic elastomer) commercially available from E.I. Du Pont de Nemours and Company, Inc., Wilmington, Del., USA. [under the trade designation: “Hytrel™ 4056”.]

“Colour Masterbatch” a precompounded plastic pellet available from Dupont de Nemours under the trade designations “Green Colour Masterbatch” or “White Colour Masterbatch”, or “Brown Colour Masterbatch” made with:

50% by weight of Hytrel™ 5526 from Dupont de Nemours, plus
50% by weight of dye in powder form, the dye being commercially available under the trade designations “Sicoversal H Vert 99.02.0229” (green colour) or “Sicoversal H. Blanc 00.02.317” (white colour), or “Sicoversal H Marron RAL 8017” (brown colour) from BASF Coatings S.A.S., Zone Industrielle de Breuil le Sec, 60676 Clermont de l'Oise Cedex, France.

“Orgalloy R 6600” a polyamide/polypropylene blend commercially available from Elf Atochem, Uerdinger Strasse 5, D-40474 Düsseldorf, Germany. [under the trade designation: “Orgalloy R 6600”]

“Pebax 3533” a polyether block amide commercially available from Elf Atochem, Uerdinger Strasse 5, D-40474 Düsseldorf, Germany. [under the trade designation: “Pebax 3533”]

“Pebax 6333” a polyether block amide commercially available from Elf Atochem, Uerdinger Strasse 5, D-40474 Düsseldorf, Germany. [under the trade designation: “Pebax 6333”]

“Hostalen GM50-50” a rigid polyethylene polymer commercially available from Elenac (BASF/Shell), Basell Polyolefine GmbH, Rheinstrase 4G, 55116 Mainz, Germany. [under the trade designation: “Hostalen GM50-50”.]

“Cork #2-3” cork granules commercially available from Société au Liegeur, 9, Avenue du Maréchal Leclerc—BP 41, 40141 Soustons, Cedex, France. [under the trade designation: “Cork #2-3”.]

“P50 Alodur BFRPL” 50 grit aluminium oxide abrasive grains, commercially available from Treibacher, Vallach Austria. [under the trade designation “P50 Alodur BFRPL”.]

“P120 Alodur BFRPL” 120 grit aluminium oxide abrasive grains, commercially available from Treibacher, Vallach Austria. [under the trade designation “P120 Alodur BFRPL”.]

“P36 grade Silicon Carbide” commercially available from Kempten GmbH, Grefrath, Germany. [under the trade designation “P36 grade Silicon Carbide”.]

“Abrasive Agglomerates”

The method of manufacture of the abrasive agglomerate is as described in WO02/33019, with the exception that thermally cured resole phenol-formaldehyde resin was used in place of radiation cured acrylic resin. Also the particles were in the form of ceramic aggregate precursor particles combining abrasive particles and cured organic binder, and not subjected to the final high temperature firing process which transforms the particles into ceramic aggregate particles. The abrasive particles were Al₂O₃ heat treated fused aluminium oxide abrasive grains, commercially available from Treibacher, Villach, Austria, under the trade description ALODUR BFRPL.

The resole phenol-formaldehyde resin was a 75% by weight solids aqueous dispersion of a resole phenol-formaldehyde resin, having a phenol to formaldehyde ratio of 1.5 to 2.0:1 and catalysed with 2.5% by weight of resin with sodium hydroxide.

The agglomerates comprised from 55 to 85% by weight aluminium oxide, 5 to 15% by weight phenolic resin, 1 to 5% by weight amorphous silicate and 10 to 25% by weight inorganic fluoride.

“P36 abrasive agglomerate” is made as above using P36 grit Alodur BFRPL. “P50 abrasive agglomerate” is made as above using P50 grit Alodur BFRPL. “P120 abrasive agglomerate” is made as above using P120 grit Alodur BFRPL.

The agglomerate particles of the P36, P50 and P120 abrasive agglomerates were approximately cylindrical in shape, the length and diameter of the cylinders being approximately equal. 41% by weight of the particles were between 1 mm and 2 mm in diameter and length, 58% by weight of the particles were between 0.5 mm and 1 mm in diameter and length, and the balance of 1% by weight were fine particles of random shape of less than 0.5 mm in size.

### Binder Formulations

Binder Formulation 1

| Raw Material | Weight % |
|---|---|
| Hytrel 6356 | 62 |
| Hytrel 5526 | 14 |
| MB 50-010 | 20 |
| Colour Masterbatch | 4 |
| Total | 100 |

Binder Formulation 2

| Raw Material | Weight % |
|---|---|
| Hytrel 6356 | 84 |
| Hytrel 5526 | 16 |
| Total | 100 |

Binder Formulation 3

| Raw Material | Weight % |
|---|---|
| Hytrel 6356 | 84 |
| MB 50-010 | 16 |
| Total | 100 |

Binder Formulation 4

| Raw Material | Weight % |
|---|---|
| Hytrel 5526 | 84 |
| MB 50-010 | 16 |
| Total | 100 |

Binder Formulation 5

| Raw Material | Weight % |
|---|---|
| Hytrel 4056 | 84 |
| MB 50-010 | 16 |
| Total | 100 |

Binder Formulation 6

| Raw Material | Weight % |
|---|---|
| Hytrel 4056 | 41.4 |
| Hytrel 5526 | 41.4 |
| MB 50-010 | 15.8 |
| Colour Masterbatch | 1.4 |
| Total | 100 |

Binder Formulation 7

| Raw Material | Weight % |
|---|---|
| Hytrel 7246 | 82.3 |
| MB 50-010 | 15.7 |
| Colour Masterbatch | 2.0 |
| Total | 100 |

Binder Formulation 8

| Raw Material | Weight % |
|---|---|
| Orgalloy R6600 | 84 |
| MB 50-010 | 16 |
| Total | 100 |

Binder Formulation 9

| Raw Material | Weight % |
|---|---|
| Pebax 3533 | 84 |
| MB 50-010 | 16 |
| Total | 100 |

Binder Formulation 10

| Raw Material | Weight % |
|---|---|
| Pebax 6333 | 84 |
| MB 50-010 | 16 |
| Total | 100 |

Binder Formulation 11

| Raw Material | Weight % |
|---|---|
| Hostalen GM 50-50 | 84 |
| MB 50-010 | 16 |
| Total | 100 |

### Test Methods

### Test Method 1 (Cut and Wear)

### Scope:

This tests cut and wear using five slow passes on an aluminium plate to quantify cut performance and wearing of the disc,

### Equipment:

ABB Robot IRB 3000, available from Asea Brown Boveri, ABB MC F-95310, Saint Ouen L'Aumone, France.

AEG 600 Watt Right Angle Grinder available from Leroy Merlin, 14, Bd Victor Bordier, 95370 Montigny-les-Cormeilles, France.

### Tool:

The tool used for this test is an AEG 600 watt right angle grinder. This tool is rated at 10000 rpm no load speed, and runs from 9600 rpm to 9700 rpm during the cut test. The actual running speed is verified using a piece of reflective tape on the mandrel, and an electronic strobe tachometer.

The disc holder is an extra hard Roloc™ Disc Holder available from 3M France—Bd de l'oise 95000 Cergy, France, the same size as the disc being tested.

### Consumable Test Materials

The cut test uses a 240 mm by 480 mm by 3 mm thick aluminum plate bolted to the robot worktable. The test material is aluminum: reference Ag3, supplied by: CTA/BONIAZ, 50, Avenue des Chataigners, 95150 Taverny, France.

### Test Description:

The aluminum plate and abrasive disc are both weighed before the test begins and again after the test is completed. The aluminum panel is used one time only per location (always on a virgin surface). Both top and bottom of the aluminum panel can be used for testing.

The tool holder must be balanced for the tool used before the first test begins, the actual working force is then measured by using a force meter to measure load while dynamically raising and lowering the tool. The measurement is the range of maximum and minimum force, which is measured when the balanced tool is rising and falling.

The aluminum plate is bolted to the robot table, and the abrasive disc installed on the Roloc™ holder attached to the angle grinder. The robot is then started.

The robot brings the abrasive disc into contact with the plate (starting at one of the long sides of the plate), traverses across the plate (240 mm travel), lifts, returns and then repeats the cycle.

Each test consists of 5 strokes in total. Traverse speed is 12.5 mm/sec, and contact pressure is 23-34 N. The test is always started on a fresh surface of the plate. The program for this test is recorded in the robot's memory as program referenced “65”.

The cut measurement is the difference between the start weight and finish weights of the aluminum plate. The weight loss of the abrasive disc provides a wear rate.

The Robot holds the abrasive disk at a 13 degree angle from vertical while performing the cut test, the contact is in a trailing fashion.

### Test Instructions

Sample description and preparation:
Abrasive disc samples should be a minimum of 48 hours old before use in this test to minimize effect of crystallization of the polymer.
Samples should be at normal atmospheric conditions for at least one hour before beginning testing.

### Test Procedure:

Install mounting hardware for aluminium plate on robot table
Install AEG 600 watt right angle electric grinder on robot
Install the Roloc™ holder on the electric grinder
Balance robot pressure actuator with grinder weight
Measure and record dynamic working pressure of the grinder. The appropriate pressure should be 25N in retraction, and 35N in compression. Adjust pressure set point in program if the range is different

Before beginning each cut test,
Record the identification of the abrasive disc
Record the initial weight of the abrasive disc
Record the total starting weight of the aluminium panel
Install the abrasive disc in the holder on the grinder.
Install the aluminium panel
Check rpm of tool during cut test

### Run Robot Test #65

At the end of each cut test
Remove the aluminium plate
Remove the abrasive disc
Record the weight of the abrasive disc
Record the weight of the aluminium panel

### Test Results and Calculations:

Cut is the difference between the aluminium plate before the test and after the test, measured in grams
Wear is the difference between the initial weight of the disc and the final weight of the disc measured in grams.

### Test Method 2 (Cut and Wear Test on Electric Angle Sander)

### Objective: To Assess the Cut and the Wear of a Surface Conditioning Product

### Summary:

The testing method simulates the removal of a welding cord, to that effect, a steel section is brought into contact with a surface conditioning rotating disc on a sander.

This test measures the removal of material (in grammes) and the life expectancy of a product (in seconds) This test is aggressive and does not allow the measuring of the actual lifespan of a product but the positioning of different products in relation to one another according to their performances.

### Consumables:

Test pieces are made from flat drawn steel bars A-37-3, 100, 300 mm long, by 15 mm wide and 5 mm thick. Supplier: CTA/BONIAZ, 50 Avenue des Chataigniers, 95150 Taverny, France.

### Description of the Equipment:

An electric Hitachi G13 SE angle sander rotating at 10 000 rpm, with a power of 1000 Watts, available from Hitachi Power Tools France S. A. Parc De L'eglantier, 22 Rues Des Cerisiers, Lissers C.E. 1541, 91015 Evry Cedex, France a table of pneumatic appliance; a system regulating the rate of feed and release of the bar; a dynamometer, to verify the force transmitted by the appliance; a vice; a support mounted on rollers; scales to a precision of 0.01 grammes; a digital chronometer (precise to 1 second); a lifting guide; a backstand, equipped with a solid contact wheel, 200 mm in diameter, 70 mm wide and a hardness of 40 Shores; a turret. Contact is made between the disc and the corner of the bar at the 15 mm and 5 mm sides, with the 15 mm side of the bar parallel to a diameter of the disc offset by 47 mm.

### Adjustment Procedure/Test Preparation:

Adjustment of the system: The pressure in the appliance is adjusted by way of a manometer situated on the left side of the table, opening the air intake valve and turning the regulator on the left of the appliance. The pressure must be checked regularly on the manometer, in order to check that there is no loss of pressure.

Before each test, the pressure is put up to 5 bars, then adjusted to the desired level in order to get rid of possible impurities in the pneumatic jack. The appliance is equipped with a system allowing the bar to come into contact with the disc and to retract. This system is set and must not be modified since this would lead to varying results from one test to another. The speed of movement of the table is also adjustable by means of 2 air inlets. It is therefore possible to adjust the speed of feed and the speed of release.

### Preparation of the Test Pieces:

In the first instance, it is necessary to raise the bars on an abrasive band with the help of a guide provided for that purpose. The guide is a system making possible the feed of the bar on the band in an identical way for each bar, the pressure applied when the contact is established is constant and equal to 40 N. A weight of 3.4 kg connected to the tray by a cable and a pulley provides this pressure. A bar is fixed in the vice of the guide, place the guide in such a way that the bar is perpendicular to the band, to achieve that, the support must be in contact with the casing of the back stand, slowly releasing the table of the appliance, leave the bar in contact for 3 seconds and bring back the table to the initial position, repeating the operation for each section of the bar. In a second phase, it is necessary to de-burr the raised bars, in order to do so, using an abrasive wheel, putting the bar into contact at right angles to wheel for 1 or 2 seconds for each section of the bar, at each end. It is necessary to check that there is no cutting edge remaining.

### Test Procedure:

The first 4 bars are weighed separately in order to have the initial section of the product tested, then the bars are used in batches of 4 (4×10 seconds) except the first 4. Weighing of the batch of bars, recording of the initial weight (P1)

Weighing of the disc to be tested, recording of the initial weight (P 2)

Position the bar in the vice and tighten it (the section of the bar must not be more than 2 cm from the disc otherwise, the movement of the appliance might be too short, place the disc in the ‘instalock’ of the sander, making sure that it is fixed properly.

Switch the grinder on, check that the disc is still well centred and release the appliance with the 2 position switch placed on the left of the testing system, the bar is put automatically into contact with the disc, leave the bar in contact for 10 seconds (to measure these 10 seconds use a chronometer, start it when the first sparks appear and recall the appliance when the 10 appears on the chronometer.

Changing the position of the switch brings the table back to the initial position and all we have to do is replace the bar with a new bar from the same batch weighed initially.

When the 4 bars have been used, weigh them and record the final weight (P 3). Repeat the operation as many times as necessary until the tested disc is completely worn. Weigh the disc at the end of the test (P 4).

At the end of the test, dust the machines and the accessories with the help of a blower.

### Comments

4 bars correspond to 4×10 seconds, it is very important to put a cold surface in contact with the disc, otherwise, the disc loads up with particles of molten steel and loses all its cutting efficiency (‘glazing’) which invalidates the test, this is the reason why the use of 4 different bars is adopted.

When the test is finished, it is necessary to bring the control table back to its initial position rapidly to prevent damage to the tray (disc support, see test procedure)

The end of the test is characterised by a strong cutting reduction (therefore of sparks) and a dull noise; the scrim has been reached.

### Calculations and Results:

The weights read on the batches of 4 bars allow the calculation of material removal (cut) corresponding to each batch of bars (i.e. 40 seconds).

### That is: (P1−P3)=Cut

The weights read on the tested disc allow the calculation of loss of material

### That is: (P2−P4)=Wear

### Report:

These results allow the comparison of the resistance of products to wear and the evolution of the cutting power of the product on the number of cycles executed. The results are presented in the form of a table and a graph.

### Test Method 3 (Roughness Measurements):

Test standard: DIN 4768-ANSI B 46.1
Equipment: Profilometer Model M3 with Tip: NHTB-100 available from MAHR GmbH, Brauweg 38, D-37073 Gottingen, Germany.

### Equipment and Process Conditions.

### Injection Moulding Machines

Vertical orientation injection moulding machine models Allrounder 270-90-350 and 270-90-500 were used available from Arburg GmbH+Co KG, Arthur-Hehl-Str., 72290 Lossburg, Germany.

Machine #270-90-350 had a Clamping Force of 350 kN maximum, a Mould Opening Stroke of 325 mm max., a Mould Height of 225 mm minimum, a Daylight maximum of 550 mm, an Ejector Force of 31.4 kN max., an Ejector Stroke of 125 mm max. In these examples the Injection Unit had the following: Screw Diameter of 22 mm, Screw Length of 20.5 L/D, Screw Stroke of 100 mm max., Swept Volume of 38 cc max., Shot Capacity of 32 g max., Injection Pressure of 2400 bar max., Injection Flow of 58 cc/s max., Screw Rotation Speed of 525 rpm max., Screw Circumferential Speed of 36 m/minute max., Screw Torgue of 290 Nm max.

Machine #270-90-500 had a Clamping Force of 500 kN maximum, a Mould Opening Stroke of 325 mm max., a Mould Height of 225 mm minimum, a Daylight maximum of 550 mm, an Ejector Force of 31.4 kN max., an Ejector Stroke of 125 mm max. In these examples the Injection Unit had the following: Screw Diameter of 25 mm, Screw Length of 18 L/D, Screw Stroke of 100 mm max., Swept Volume of 49 cc max., Shot Capacity of 41 g max., Injection Pressure of 1860 bar max., Injection Flow of 98 cc/s max., Screw Rotation Speed of 725 rpm max., Screw Circumferential Speed of 57 m/minute max., Screw Torgue of 290 Nm max.

The following process conditions were used, unless otherwise stated: Heating Zone Temperatures: Zone 1: 225° C., Zone 2: 240° C., Zone 3: 245° C., Nozzle: 250° C., Mould: 80° C.; Injection Flow: 39 cc/s; Injection Time: 1.4 seconds; Injection Pressure: 25% of maximum.

### Desiccator.

Desiccator used was a model Trockenlufttrockner Digicolor KTT 100 available from Digicolor, Gesellschaft fur Kunstoffmaschinentechnik mbH, Eckendorfer Strasse 125a, 33609, Bielefeld, Germany. The following process conditions were used, except where noted: Time: 2 hours; Temperature: 80° C.

### EXAMPLES

### Examples 1.1 to 1.3

Vertical orientation injection moulding machine model “Allrounder” 270-90-350 was used with the mould described with reference to FIGS. 1(a) and (b). In these Examples a flat disc of polypropylene mesh, Ref. 5000, commercially available from Intermas Nets S.A., Ronda de Collsabadell, 11-08450, Llinars Del Valles, Spain was placed over the abrasive agglomerate/particles.

10 grams of Binder Formulation 1 was used in each Example.

### Example 1.1

### Invention

2 grams of P120 abrasive agglomerate was used.

### Example 1.2

### Comparative

2 grams of P50 Alodur BFRPL was used.

### Example 1.3

### Comparative

2 grams of P120 Alodur BFRPL was used.

### Observations:

### Example 1.1

The sample exhibited good encapsulation of the abrasive agglomerate.

### Example 1.2

The sample exhibited poor encapsulation of the abrasive that was concentrated to the outside of the disc. Abrasive grain easily removed from surface of disc by hand pressure.

### Example 1.3

The sample exhibited poor encapsulation of the abrasive that was concentrated to the outside of the disc. Abrasive grain easily removed from surface of disc by hand pressure.

Conclusions: These Examples, using a basic mould cavity, demonstrated improved encapsulation of abrasive agglomerate in accordance with the invention compared to the use of straight abrasive grain

### Examples 2.1 to 2.3

Vertical orientation injection moulding machine model “Allrounder” 270-90-350 was used with the mould described with reference to FIG. 3. The abrasive was placed in the annular recess.

6.5 grams of Binder Formulation 1 was used in each Example 2.1 to 2.3.

### Example 2.1

### Invention

Abrasive used was P36 abrasive agglomerate, quantity was 5 grams. Injection flow: 49 cc/sec.

### Example 2.2

### Invention

Abrasive used was P50 abrasive agglomerate, quantity was 5 grams. Injection flow: 98 cc/sec.

### Example 2.3

### Comparative

Abrasive used was P36 grade Silicon Carbide, quantity was 4 grams. Injection flow: 49 cc/sec.

### Observations:

### Example 2.1

The sample exhibited good encapsulation of the agglomerate in general except for some small areas where the encapsulation was not complete.

### Example 2.2

The sample exhibited good encapsulation of the agglomerate in general except for some small areas where the encapsulation was not complete.

### Example 2.3

Compared with the samples of Examples 2.1 and 2.3, the abrasive grains of this sample seemed to be pushed more to the wall of the mould.

### Testing:

The sample of Example 2.1 was tested according to Test Method 1, in comparison with a “Standard” non-woven abrasive disc product sold under the trade designation “Roloc™ Surface Conditioning Disc A CRS” available from 3M Corporation, 3M Center, St. Paul, Minn. 55144-1000, USA. Results are summarised in Table 1.

TABLE 1

| | Standard | | Standard | Example 2.1 | Linear |
|---|---|---|---|---|---|
| | Cut | Example 2.1 | Wear | Wear | metres |
| Cycle # | (grams) | Cut (grams) | (grams) | (grams) | processed |
| 1 | 2.7 | 2.4 | 0.34 | 0.07 | 1.1 |
| 2 | 2.4 | 1.9 | 0.29 | 0.09 | 2.2 |
| 3 | 2.3 | 1.7 | 0.24 | 0.1 | 3.3 |
| 4 | 2.2 | 2 | 0.22 | 0.1 | 4.4 |
| 5 | 2.1 | 1.7 | 0.15 | 0.08 | 5.5 |
| 6 | 1.8 | 2.1 | 0.14 | 0.11 | 6.6 |
| 7 | 1.8 | 2.5 | 0.11 | 0.13 | 7.7 |
| 8 | 1.8 | 2.1 | 0.13 | 0.1 | 8.8 |
| 9 | 1.4 | 1.8 | 0.08 | 0.1 | 9.9 |
| 10 | 1.3 | 2.2 | 0.07 | 0.08 | 11 |
| 11 | 1.1 | 1.8 | 0.08 | 0.1 | 12.1 |
| 12 | 1.2 | 1.6 | 0.07 | 0.12 | 13.2 |
| 13 | 1.3 | 1.9 | 0.09 | 0.12 | 14.3 |
| 14 | 1 | 2.2 | 0.06 | 0.14 | 15.4 |
| 15 | 1.1 | 2.1 | 0.05 | 0.15 | 16.5 |
| 16 | 1.3 | 1.9 | 0.05 | 0.12 | 17.6 |
| 17 | 1.2 | 2 | 0.05 | 0.11 | 18.7 |
| 18 | 1.1 | 2 | 0.04 | 0.13 | 19.8 |

Note:
The weight figures given in each column are the weights lost in each cycle.

Conclusions from Table 1

The Cut value cycle after cycle is quite constant in the range 1.8 to 2.2 g lost per cycle for Example 2.1, therefore it appears that the cut is more stable than the standard product. The Wear value is quite consistent and uniform in the range of 0.1 g per cycle for Example 2.1 as opposed to the standard product where the Wear decreases in use. Therefore Example 2.1 shows better consistency.

Before and after the tests shown in Table 1, the substrates were tested for roughness according to Test Method 3. Results are summarised in Table 2.

TABLE 2

| | Ra | Rz | Rt |
|---|---|---|---|
| Standard (initial) | 1.0 | 6.1 | 7.9 |
| | (0.1) | (1.0) | (2.5) |
| Standard (after 18 cycles) | 1.1 | 6.9 | 8.5 |
| | (0.2) | (1.2) | (1.5) |
| Example 2.1 (initial) | 2.5 | 13.2 | 16.4 |
| | (1.1) | (3.5) | (4.3) |
| Example 2.1 (after 18 cycles) | 2.0 | 12.2 | 14.9 |
| | (0.4) | (2.6) | (2.5) |

Where:
Ra is the “Roughness Average” - the arithmetic mean of the absolute height of roughness irregularities measured from a mean line within the evaluation length.
Rz is the “Mean Roughness Depth” - the mean of five maximum peak-to-valley roughness depths in five successive sampling lengths.
Rt is the “Maximum Roughness Depth” - the vertical distance between the highest peak and the deepest valley within the sampling length.
The figures in brackets represent the Standard Deviation.

Conclusions from Table 2:
1. Roughness measurements between the beginning and end of life of disc remains constant for both products, therefore Example 2.1 is comparable to a standard product in consistency of the finish.
2. The Ra roughness figures for Example 2.1, in the range of 2.0 to 2.5, are lower than would be expected for a non-overmoulded product containing the same 36 grit size (>3.0). Therefore the product produces a finer finish.
   Overall Conclusions from Examples 2.1 to 2.3:

These Examples showed the contribution of cavity geometry of the mould in holding abrasive grains or agglomerate in place, and testing showed the consistency of the cut and of the wear of the product.

### Examples 3.1 to 3.18

Vertical orientation injection moulding machine model “Allrounder” 270-90-500 was used with the mould described with reference to FIGS. 6 and 7.

50 grams of P24 abrasive agglomerate, plus 55 grams of binder were used in each Example, unless otherwise stated. The abrasive was inserted in the annular recess.

Abrasive agglomerate was desiccated for 2 hours at 80° C.

Unless noted, abrasive agglomerate was screened using a mesh No. 14, retaining agglomerate larger than 1400 microns, from Retsch GmbH & Co. KG, Rheinische Straβe 36, 42781 Haan, Germany.

### Example 3.1

Binder Formulation 1 was used.

### Example 3.2

Binder Formulation 2 was used. Abrasive agglomerate was not screened.

### Example 3.3

Binder Formulation 3 was used. Abrasive agglomerate was not screened.

### Example 3.4

Binder Formulation 4 was used.

### Example 3.5

Binder Formulation 5 was used. Abrasive agglomerate was not screened. A lower nozzle temperature of 230° C. was used.

### Example 3.6

Binder Formulation 5 was used. A lower nozzle temperature of 230° C. was used

### Example 3.7

Binder Formulation 6 was used.

### Example 3.8

Binder Formulation 7 was used. Abrasive agglomerate was not screened. A higher nozzle temperature of 260° C. was used

### Example 3.9

Binder Formulation 7 was used.

### Example 3.10

Binder Formulation 8 was used. Abrasive agglomerate was not screened.

### Example 3.11

Binder Formulation 8 was used.

### Example 3.12

Binder Formulation 9 was used. Abrasive agglomerate was not screened. A lower nozzle temperature of 230° C. was used.

### Example 3.13

Binder Formulation 9 was used. A lower nozzle temperature of 230° C. was used

### Example 3.14

Binder Formulation 10 was used. Abrasive agglomerate was not screened. A higher nozzle temperature of 260° C., and a higher mould temperature of 100° C., were used.

### Example 3.15

Binder Formulation 10 was used. A higher nozzle temperature of 260° C., and a higher mould temperature of 100° C., were used.

### Example 3.16

Binder Formulation 10 was used. Abrasive agglomerate was not screened. A higher nozzle temperature of 260° C., and a higher mould temperature of 120° C., were used.

### Examples 3.17

Binder Formulation 11 was used. Abrasive agglomerate was not screened.

### Example 3.18

Binder Formulation 1 was used. 30 grams of P24 abrasive agglomerate plus 0.4 grams of Cork #2-3 were used.

### Observations:

### Example 3.1

Rigid product with acceptable visual grit separation.

Note: Various rigidity products can be tailored for specific applications, for example a more flexible product will be applicable for surface refinement whereas a more rigid product will be used for light stock removal.

### Example 3.2

Rigid product with poorer visual appearance than the sample of 3.1. The product smeared (leaving a deposit on substrate) in use. Binder Formulation 2 did not contain a lubricant which was present in Binder Formulation 1 used in Example 3.1.

### Example 3.3

Less rigid product, compared to Example 3.1. Acceptable visual appearance, but not as good as Examples 3.1.

### Example 3.4

Less rigid product, compared to Example 3.1. Acceptable visual appearance, but not as good as Example 3.1.

### Example 3.5

Flexible product compared to Example 3.1, with good visual appearance.

### Example 3.6

Flexible product compared to Example 3.1, with good visual appearance.

### Example 3.7

Semi flexible product compared to Example 3.1, with good visual appearance.

### Example 3.8

More Rigid product compared to Example 3.1, with poorer visual appearance.

### Example 3.9

More Rigid product compared to Example 3.1, with poorer visual appearance.

### Example 3.10

Very rigid product compared to Example 3.1, with good visual appearance. Darker surface appearance compared to Examples 3.11 indicating that wider particle size distribution of unscreened abrasive agglomerate resulted in a suitable incorporation and encapsulation of the agglomerate in the plastic matrix.

### Example 3.11

Very rigid product compared to Example 3.1, with good visual appearance.

### Example 3.12

Flexible product compared to Examples 3.1, with good visual appearance. Darker surface appearance compared to Examples 3.13 indicating that wider particle size distribution of unscreened abrasive agglomerate resulted in a suitable incorporation and encapsulation of the agglomerate in the plastic matrix.

### Example 3.13

Flexible product compared to Example 3.1, with good visual appearance. Darker surface appearance indicating that wider particle size distribution of unscreened abrasive agglomerate resulted in a suitable incorporation and encapsulation of the agglomerate in the plastic matrix.

### Example 3.14

Rigid product, similar to Example 3.1. Poorer visual appearance.

### Example 3.15

Rigid product, similar to Example 3.1, with good visual appearance.

### Example 3.16

Rigid product, similar to Examples 3.1, with good visual appearance. Darker surface appearance compared to Examples 3.15, indicating that the wider particle size distribution of unscreened abrasive agglomerate resulted in a suitable incorporation and encapsulation of the agglomerate in the plastic matrix.

### Examples 3.17

Rigid to brittle product compared to Example 3.1, poorer visual appearance.

### Example 3.18

Moulding performance was improved by the presence of cork with no evidence of flashing with the product requiring no post-forming removal of flash, as required with Examples 3.1 to 3.17.

### Testing:

Representative samples were tested according to Test Method 2. Results are recorded in Table 3.

TABLE 3

| | Number | Initial | Final | | | | | |
|---|---|---|---|---|---|---|---|---|
| Product | of discs | disc | disc | Initial | | | | Total |
| identification | tested | weight | weight | cut (g) | 20 s | 30 s | 40 s | 40 s |
| Example 3.7 | 1 | 105.23 | 63.26 | 0.7 | 0.8 | 0.9 | 1.1 | 3.5 |
| Example 3.4 | 1 | 105.44 | 101.11 | 0.5 | 0.5 | 0.6 | 0.8 | 2.4 |
| Example 3.9 | 1 | 108.57 | 15.20 | 0.45 | 0.6 | 0.6 | 0.6 | 2.3 |
| Example 3.15 | 1 | 98.24 | 95.07 | 0.5 | 0.9 | 0.9 | 0.55 | 2.9 |
| Standard | | 23.14 | 22.53 | 0.70 | 0.45 | 0.50 | 0.45 | 2.10 |

| Total | 80 s | 120 s | 160 s | 200 s | 240 s | 280 s | 320 s | 360 s | 400 s | 440 s | 480 s | 520 s | 560 s | 600 s | 640 s | 680 s | 720 s | 760 s | 800 s | 840 s |
|---|---|---|---|---|---|---|---|---|---|---|---|---|---|---|---|---|---|---|---|---|
| 3.5 | 4.1 | 5.1 | 3.8 | 0.45 | | | | | | | | | | | | | | | | |
| 2.4 | 2.8 | 2.7 | 2.8 | 1.75 | 2 | 2.1 | 1.6 | 1.7 | 1.8 | 1.2 | 1.2 | 1 | | | | | | | | |
| 2.3 | 2.8 | 3.1 | 2.4 | 1.6 | 2 | 1.9 | 1.7 | 1.5 | 1.4 | 0.8 | 1.2 | 1.55 | 1.7 | 1.2 | 0.8 | 0.6 | 0.4 | | | |
| 2.9 | 2.3 | 1.6 | 1.7 | 1.65 | 1.35 | 1.5 | 1.5 | 1.2 | 1.3 | 1.2 | 1.3 | 1.1 | 1.1 | 1 | 1.1 | 1.3 | 1.2 | 1.2 | 1 | |
| 2.10 | 1.55 | 1.10 | | | | | | | | | | | | | | | | | | |

Note 1:
“Standard” indicates a product used as comparison: a standard non-woven abrasive disc product commercially available from 3M Corporation, 3M Center, St. Paul, Minnesota 55144-1000, USA, under the trade designation “Roloc(TM) Surface Conditioning Disc A CRS”
Note 2:
The figures quoted in column entitled “Initial cut” is the weight lost between start of test and 10 seconds. The figures quoted in column entitled 20 seconds is the weight lost between 10 seconds and 20 seconds, and so on. The figure quoted in column entitled “Total 40 s” is the sum of the weights in the columns before 40 seconds, and is listed in order to make comparison with later columns. “Initial cut” and the weight lost before 40 seconds are useful properties as they represent the user's initial reaction to the product in use.

Conclusions from Table 3:

Example 3.7 shows that the life (time when the product is cutting) is shorter compared with 3.4, 3.9 or 3.15 possibly because the agglomerate distribution was not as even.

Examples 3.7, 3.4, 3.9 and 3.15 are long lasting products compared with the Standard product.

1-28. (canceled)

29. A method for making an abrasive article comprising positioning particles of abrasive agglomerate in at least a portion of an abrasive article mould, injecting molten thermoplastic binder resin into the abrasive article mould and allowing the thermoplastic binder resin to cool such that the particles of abrasive agglomerate are secured within the thermoplastic binder resin.

30. A method as claimed in claim 29 for making an abrasive article in which particles of abrasive agglomerate have a particle size of at least 0.5 mm by sieve analysis.

31. A method as claimed in claim 29 in which the abrasive agglomerate comprises a plurality of abrasive grains bonded by a cured organic binder.

32. A method as claimed in claim 31 in which the agglomerates comprise from 55 to 85% by weight abrasive grains, 5 to 15% by weight phenolic resin, 1 to 5% by weight amorphous silicate and 10 to 25% by weight inorganic fluoride.

33. A method as claimed in claim 29 in which the mould cavity is filled with particles of abrasive agglomerate prior to injecting the molten thermoplastic binder resin.

34. A method as claimed in claims 29 in which the mould cavity comprises at least one recess in which the particles of abrasive agglomerate are positioned.

35. A method as claimed in claim 34 in which the particles of abrasive agglomerate partly, fill said at least one recess and a screen, web, scrim, membrane or mesh which allows passage of molten thermoplastic binder therethrough but does not allow passage of the particles of abrasive agglomerate therethrough is placed over the particles of abrasive agglomerate.

36. A method as claimed in claim 29 in which the thermoplastic binder is selected from polycarbonate, polyetherimide, polyester, polyethylene, polysulfone, polystyrene, polybutylene, acrylonitrile-butadiene-styrene block copolymer, polypropylene, acetal polymers, polyurethanes, polyamides and combinations thereof.

37. A method as claimed in claim 29 in which the thermoplastic binder resin comprises a lubricant.

38. A method as claimed in claim 29 in which the thermoplastic binder additionally comprises up to 20% by weight of a filler.
